(19) United States
(12) Patent Application Publication
(10) Pub. No.: US 2017/0200949 A1
(43) Pub. Date: Jul. 13, 2017

(54) COPPER-CONTAINING SILICON MATERIAL, METHOD FOR PRODUCING SAME, NEGATIVE ELECTRODE ACTIVE MATERIAL, AND SECONDARY BATTERY

(71) Applicant: KABUSHIKI KAISHA TOYOTA JIDOSHOKKI, Kariya-shi, Aichi (JP)

(72) Inventors: Masanori HARATA, Kariya-shi (JP); Takashi MOHRI, Kariya-shi (JP)

(73) Assignee: KABUSHIKI KAISHA TOYOTA JIDOSHOKKI, Kariya-shi, Aichi (JP)

(21) Appl. No.: 15/314,421

(22) PCT Filed: May 26, 2015
(86) PCT No.: PCT/JP2015/002647

§ 371 Date: Nov. 28, 2016

(30) Foreign Application Priority Data
May 29, 2014 (JP) 2014-110821

(51) Int. Cl. H01M 4/38; H01M 10/0525; H01G 11/86; C01B 33/06; H01G 11/50

(52) U.S. Cl. CPC H01M 4/386; C01B 33/06; H01G 11/50; H01G 11/86; H01M 10/0525

(57) ABSTRACT

A negative electrode active material having improved electron conductivity is provided.

A reaction between an acid and a copper-containing calcium silicide represented by CaCuₓSi_{y} is caused, and a heat treatment is performed in a non-oxidizing atmosphere on the reaction product,
to obtain a copper-containing silicon material. The copper-containing silicon material contains Si and copper in an amorphous phase, and fine copper silicide is uniformly deposited within the amorphous phase. Thus, electron conductivity improves. Therefore, a secondary battery in which the negative electrode active
material is used as a negative electrode has improved rate characteristics and also has an increased charge/discharge capacity.

### TECHNICAL FIELD

The present invention relates to a copper-containing silicon material used as the negative electrode active material of a lithium ion secondary battery or the like, a method for producing the copper-containing silicon material, and a secondary battery in which the copper-containing silicon material is used as a negative electrode active material.

### BACKGROUND ART

Lithium ion secondary batteries are secondary batteries having a high charge/discharge capacity and capable of achieving high output. Currently, lithium ion secondary batteries are mainly used as power supplies for portable electronic equipment, and are expected to be used as power supplies for electric vehicles assumed to be used widely in the future. Lithium ion secondary batteries have, respectively in a positive electrode and a negative electrode, active materials capable of inserting and eliminating lithium (Li) therein/therefrom. The lithium ion secondary batteries operate when lithium ions move through an electrolytic solution provided between the two electrodes.

In lithium ion secondary batteries, a lithium-containing metallic complex oxide such as a lithium cobalt complex oxide is mainly used as the active material for the positive electrode, and a carbon material having a multilayer structure is mainly used as the active material for the negative electrode. The performance of a lithium ion secondary battery is influenced by materials of the positive electrode, the negative electrode, and the electrolyte that are included in the secondary battery. Research and development are actively conducted for active material substances forming the active materials. For example, usage of silicon or a silicon oxide having a higher capacity than carbon is discussed as a substance for the negative electrode active material.

When silicon is used as the negative electrode active material, a battery with a capacity higher than when a carbon material is used is obtained. However, silicon undergoes a large volume change associated with occlusion and release of Li during charging and discharging. Thus, in a secondary battery in which silicon is used as a negative electrode active material, silicon turns into fine powder to undergo a structural change during charging and discharging and becomes eliminated or detached from a current collector as a result. Therefore, this secondary battery has a problem of short charge/discharge cycle life of the battery. For that reason, a technique to suppress a volume change associated with occlusion and release of Li during charging and discharging by using a silicon oxide as a negative electrode active material, as compared to silicon, is discussed.

For example, usage of a silicon oxide (SiOₓ: x is about 0.5≦x≦1.5) is discussed as the negative electrode active material. SiOₓ, when being heated, is known to decompose into Si and SiO₂. This is referred to as a disproportionation reaction in which a solid separates into two phases, i.e., Si phase and SiO₂ phase, through an internal reaction. The Si phase obtained from the separation is extremely fine. In addition, the SiO₂ phase that covers the Si phase has a function of suppressing decomposition of the electrolytic solution. Thus, the secondary battery using the negative electrode active material formed of SiOₓ that has been decomposed into Si and SiO₂ has excellent cycle characteristics.

The cycle characteristics of the secondary battery improve further when finer silicon particles forming the Si phase of the SiOₓ described above are used as a negative electrode active material in the secondary battery. JP3865033 (B2) (Patent Literature 1) discloses a method of heating metal silicon and SiO₂ to sublimate those into a silicon oxide gas, and cooling the gas to produce SiOₓ.

JP2009102219 (A) (Patent Literature 2) discloses a production method including decomposing a silicon raw material into an elemental state in a high temperature plasma, rapidly cooling it to the temperature of liquid nitrogen to obtain silicon nano particles, and fixing the silicon nano particles into a SiO₂—TiO₂ matrix by using a sol-gel method or the like.

In the production method disclosed in Patent Literature 1, the materials are limited to sublimable materials. Moreover, irreversible Li is known to be generated at the negative electrode due to change of the SiO₂ phase, which covers the Si phase, into lithium silicate at the time of Li occlusion, and thus it is necessary to add an extra active material to the positive electrode. In addition, in the production method disclosed in Patent Literature 2, high energy is required for plasma discharge. Furthermore, in silicon complexes obtained from these production methods, the silicon particles of the Si phase are speculated to have low dispersibility and be easily aggregated. When the silicon particles aggregate with each other and the particle sizes thereof become large, the secondary battery using those as the negative electrode active material results in having a low initial capacity and deteriorated cycle characteristics.

In recent years, nano silicon materials that are expected for usage in semiconductors, electrics or electronics fields, and the like have been developed. For example, Physical Review B (1993), vol. 48, pp. 8172-8189 (Non-Patent Literature 1) discloses a method for synthesizing a layered polysilane by causing a reaction between hydrogen chloride (HCl) and calcium disilicide (CaSi₂), and states that the layered polysilane obtained in this manner can be used in a light-emitting element or the like.

Materials Research Bulletin, Vol. 31, No. 3, pp. 307-316, 1996 (Non-Patent Literature 2) states that plate-like silicon crystal was obtained by performing a heat treatment at 900° C. on a layered polysilane obtained by causing a reaction between hydrogen chloride (HCl) and calcium disilicide (CaSi₂).

JP2011090806 (A) (Patent Literature 3) discloses a lithium ion secondary battery in which a layered polysilane is used as a negative electrode active material.

### CITATION LIST

### Patent Literature

Patent Literature 1: JP3865033 (B2)

Patent Literature 2: JP2009102219 (A)

Patent Literature 3: JP2011090806 (A)

### Non-Patent Literature

Non-Patent Literature 1: Physical Review B (1993), vol. 48, pp. 8172-8189

Non-Patent Literature 2: Materials Research Bulletin, vol. 31, No. 3, pp. 307-316, 1996

### SUMMARY OF INVENTION

### Technical Problem

However, a secondary battery using a negative electrode active material formed from the layered polysilane disclosed in Patent Literature 3 has insufficient rate characteristics due to low electron conductivity of the layered polysilane, and also has insufficient initial efficiency. In addition, the plate-like silicon crystal disclosed in Non-Patent Literature 2 has high conductive resistance, and thus it is difficult to use the plate-like silicon crystal directly as the negative electrode active material of a secondary battery.

The present invention has been made in view of such a situation, and its problem to be solved is to provide a novel copper-containing silicon material having improved electron conductivity, a method for producing the copper-containing silicon material, a negative electrode active material using the copper-containing silicon material, and a secondary battery using the negative electrode active material as a negative electrode.

### Solution to Problem

A production method for a copper-containing silicon material of the present invention solving the above-described problem includes:

a first step of preparing a calcium source, a copper source, and a silicon source, preparing a molten metal by mixing and melting the calcium source, the copper source, and the silicon source such that calcium (Ca), copper (Cu), and silicon (Si) have a predetermined ratio as an atom ratio, and cooling the molten metal, to form a copper-containing calcium silicide having a composition of Ca, Cu, and Si represented by a formula CaCuₓSi_{y} (x and y satisfy 0.1≦x≦0.7, 1.33≦y≦2.1, and 1.8≦x+y≦2.2);

a second step of causing a reaction between the copper-containing calcium silicide and an acid that extracts calcium (Ca) from the copper-containing calcium silicide, to form a silicon precursor; and

a third step of performing a heat treatment in a non-oxidizing atmosphere on the silicon precursor.

### Advantageous Effects of Invention

The copper-containing silicon material of the present invention contains copper in an amorphous silicon phase thereof, and fine copper silicide is deposited within the amorphous silicon phase. Thus, electron conductivity improves significantly.

### BRIEF DESCRIPTION OF DRAWINGS

FIG. 1 shows XRD charts of a copper-containing calcium silicide and a copper-containing silicon material according to Example 1;

FIG. 2 is an SEM image of the copper-containing silicon material according to Example 1;

FIG. 3 is a TEM-EDX image showing a distribution of silicon (Si) of the copper-containing silicon material according to Example 1;

FIG. 4 is a TEM-EDX image showing a distribution of copper (Cu) of the copper-containing silicon material according to Example 1;

FIG. 5 is a schematic diagram showing the structure of the copper-containing silicon material according to Example 1; and

FIG. 6 shows initial charging/discharging curves of a lithium ion secondary battery according to Example 1.

### DESCRIPTION OF EMBODIMENTS

In the production method of the present invention, first, in a first step, a calcium source, a copper source, and a silicon source are prepared, a molten metal is prepared by mixing and melting the calcium source, the copper source, and the silicon source such that calcium (Ca), copper (Cu), and silicon (Si) have a predetermined ratio as an atom ratio, and the molten metal is cooled, to form a copper-containing calcium silicide. As the calcium source, metal calcium or a calcium compound such as calcium hydroxide, calcium oxide, calcium acetate, calcium carbonate, and calcium chloride may be used. Metal calcium is preferable from the standpoint of impurities reduction.

As the copper source, metal copper or a copper compound such as copper hydroxide, copper acetate, copper oxide, copper carbonate, copper cyanide, copper chloride, and organic copper compounds may be used. Metal copper is preferable from the standpoint of impurities reduction. As the silicon source, metal silicon or a silicon compound such as organic silane, silicon monoxide, silicon dioxide, silicone, and tetraethyl orthosilicate may be used. Metal silicon is preferable from the standpoint of impurities reduction.

In the first step, the above calcium source, the above copper source, and the above silicon source are mixed such that calcium (Ca), copper (Cu), and silicon (Si) have a predetermined ratio as an atom ratio, and are melted and cast. When a composition formula is defined as CaCuₓSi_{y}, the predetermined ratio is a ratio with which x and y satisfy 0.1≦x≦0.7, and 1.33≦y≦2.1, and 1.8≦x+y≦2.2.

x satisfies 0.1≦x≦0.7. x is preferably within the range of 0.2≦x≦0.6 and more preferably within the range of 0.2≦x≦0.3. y satisfies 1.33≦y≦2.1. y is preferably within the range of 1.5≦y≦2.1 and more preferably within the range of 1.65≦y≦1.85. The sum of x and y satisfies 1.8≦x+y≦2.2. The sum of x and y is preferably within the range of 1.85≦x+y≦2.15 and more preferably within the range of 1.9≦x+y≦2.0. In addition to Ca, Cu, and Si, the copper-containing calcium silicide contains impurities derived from the raw materials thereof in some cases.

When the value of x is less than 0.1 or the value of y is greater than 2.1, an obtained copper-containing silicon material has insufficient electron conductivity in some cases. When x is greater than 0.7 or y is less than 1.33, the initial capacity of a secondary battery in which the copper-containing silicon material is used as a negative electrode active material decreases in some cases. In addition, when the value of x+y is outside the above range, a reaction in a second step becomes less likely to proceed or an impurity phase is generated in a large amount in some cases.

The melting temperature may be 1100° C. to 1500° C. and more preferably 1200° C. to 1400° C. By cooling the molten metal, a copper-containing calcium silicide having a composition of Ca, Cu, and Si represented by a formula CaCuₓSi_{y} (x and y satisfy 0.1≦x≦0.7, 1.33≦y≦2.1, and 1.8≦x+y≦2.2) is obtained. The copper-containing calcium silicide is found to have a crystal structure that belongs to P6/mmm space group, when the values of x and y satisfy the above ranges. That is, in the obtained copper-containing calcium silicide, copper (Cu) atoms and silicon (Si) atoms having hexagonal structures form sheet-like graphite structures intercalated with calcium (Ca) atoms.

In the second step, a reaction between the copper-containing calcium silicide and an acid that extracts calcium (Ca) from the copper-containing calcium silicide is carried out to form a silicon precursor. In order to allow the reaction to easily proceed, the copper-containing calcium silicide is desirably ground and sized in advance. The means for grinding and sizing is not particularly limited, and conventionally-used means may be adopted.

The particle diameter of a powder of the copper-containing calcium silicide used in the second step is not particularly limited, but is preferably not greater than 100 μm and further preferably not greater than 60 μm. The lower limit of the particle diameter is preferably not less than 1 μm, since a problem may arise in handling the powder when the particle diameter is excessively small.

As the acid that extracts calcium (Ca) from the copper-containing calcium silicide, hydrochloric acid (HCl) may be used as described in Non-Patent Literature 2. However, when only hydrochloric acid (HCl) is used, an oxygen amount or a chlorine amount in the copper-containing silicon material that is a final substance becomes large in some cases. In such a case, the copper-containing silicon material is not preferable as a negative electrode active material.

Therefore, an acid containing fluorine at least in the anion thereof is preferably used. By using the acid containing fluorine at least in the anion thereof, the amount of oxygen (O) contained in the obtained copper-containing silicon material is reduced, and by containing fluorine (F), the amount of chlorine (Cl) contained in the obtained copper-containing silicon material becomes zero or is reduced. Thus, when the copper-containing silicon material is used as the negative electrode active material of a lithium ion secondary battery or the like, the initial capacity improves.

Examples of the acid containing fluorine at least in the anion thereof include hydrofluoric acid, tetrafluoroboric acid, hexafluorophosphoric acid, hexafluoroarsenic acid, fluoroantimonic acid, hexafluorosilicic acid, hexafluorogermanic acid, hexafluorostannic (IV) acid, trifluoroacetic acid, hexafluorotitanic acid, hexafluorozirconic acid, trifluoromethanesulfonic acid, and fluorosulfonic acid, etc.

As the acid that extracts calcium (Ca) from the copper-containing calcium silicide, another acid may be contained when at least one acid selected from the above acids is contained in an amount of not less than 0.01 mass %. Examples of the other acid include hydrochloric acid, hydrobromic acid, hydroiodic acid, sulfuric acid, methanesulfonic acid, nitric acid, phosphoric acid, formic acid, and acetic acid, etc.

The reaction between the acid and the copper-containing calcium silicide may be carried out under conditions that are the same as those described in Non-Patent Literature 1 and 2. The reaction is preferably carried out at a low temperature equal to or lower than room temperature, and desirably carried out on an ice bath. The silicon precursor obtained by using the acid containing fluorine at least in the anion thereof has a smaller oxygen amount and a smaller chlorine amount than a layered polysilane obtained by the method disclosed in Non-Patent Literature 1 or 2, and contains fluorine.

In the second step, when hydrofluoric acid (HF) is used as the acid containing fluorine at least in the anion thereof, hydrochloric acid (HCl) is preferably mixed therewith and used. Even when only hydrofluoric acid (HF) is used, a silicon precursor is obtained. However, the obtained silicon precursor has high activity, and becomes oxidized by a very small amount of air to increase the oxygen amount. Thus, using only hydrofluoric acid (HF) is not preferable. In addition, when only hydrochloric acid (HCl) is used, the oxygen amount in the silicon precursor becomes large in some cases.

The composition ratio between hydrofluoric acid (HF) and hydrochloric acid (HCl) is desirably within the range of HF/HCl=1/1 to 1/100 in mole ratio. Having an amount of hydrofluoric acid (HF) larger than that described in this ratio is not preferable, since a large amount of impurities such as CaF₂ and CaSiO-type may be generated and it is thought to be difficult to separate the silicon precursor from these impurities. Furthermore, when the amount of hydrogen fluoride (HF) is smaller than that described in this ratio, the etching action by hydrofluoric acid (HF) with respect to Si—O bond becomes weak, and a large amount of oxygen remains in the obtained silicon precursor in some cases.

The blend ratio between the acid and the copper-containing calcium silicide is desirably excessive for the acid than equivalency.

In addition, the reaction atmosphere is desirably an inert gas atmosphere. An excessively long reaction time may cause, for example, additional reaction between Si and HF to generate SiF₄. Thus, a reaction time of about 0.25 to 24 hours is sufficient. Although, for example, CaCl₂ or the like is generated from the reaction in the second step, CaCl₂ or the like is easily removed through rinsing with water, so that refinement of the silicon precursor is easy.

In the second step, when, for example, tetrafluoroboric acid (HBF₄) is used as the acid containing fluorine at least in the anion thereof, it is not necessary to mix hydrochloric acid (HCl) therewith, and reaction between the copper-containing calcium silicide and only tetrafluoroboric acid (HBF₄) is allowed to be carried out. The reaction conditions may be the same as described above. With this method, the obtained silicon precursor and copper-containing silicon material do not contain chlorine (C1). Thus, when the copper-containing silicon material is used as a negative electrode active material, the resistance is further reduced.

In the second step, the reaction is thought to proceed by a mechanism in which calcium (Ca) is extracted from the copper-containing calcium silicide, which has a crystal structure that belongs to P6/mmm space group. This mechanism is thought to be the same as that for the reaction to generate the layered polysilane as described in Non-Patent Literature 1 and 2. In the second step, a silicon precursor with a layered structure having a sheet-like graphite structure including a hexagonal structure formed from silicon (Si) atoms and copper (Cu) atoms, is thought to be formed.

In a third step, a heat treatment is performed in a non-oxidizing atmosphere on the silicon precursor to obtain the copper-containing silicon material of the present invention. Examples of the non-oxidizing atmosphere include a reduced pressure atmosphere, a vacuum atmosphere, and an inert gas atmosphere. The heat treatment temperature is about 350° C. to 1100° C., but is preferably equal to or higher than 400° C. and lower than 1000° C., and particularly preferably within the range of not lower than 500° C. and not higher than 900° C. The time of the heat treatment depends on the heat treatment temperature, and is sufficiently 1 hour when the heat treatment temperature is not lower than 500° C.

The copper-containing silicon material of the present invention obtained by the production method of the present invention may contain an amorphous silicon phase and copper silicide such as Cu₃Si and Cu₁₅Si₄ deposited within the amorphous silicon phase. The copper-containing silicon material is useful as various semiconductor materials, since the copper-containing silicon material contains copper (Cu) within amorphous silicon and thus has high electron conductivity. The copper (Cu) content is not particularly specified, but is preferably within the range of 1 to 50 mass %, further preferably within the range of 10 to 40 mass %, andparticularly preferably within the range of 20 to 30 mass %. Having a copper (Cu) content of less than 1 mass % is not practical, since improvement of electron conductivity is small. When the copper (Cu) content is greater than 50 mass %, the initial capacity of a secondary battery in which the copper-containing silicon material is used as a negative electrode active material decreases.

In the copper-containing silicon material of the present invention, the silicon (Si) content is preferably within the range of 50 to 99 mass %, further preferably within the range of 60 to 95 mass %, and particularly preferably within the range of 80 to 90 mass %. Having a silicon (Si) content of less than 50 mass % is not practical, since the capacity of a secondary battery in which the copper-containing silicon material is used as a negative electrode active material is low. When the silicon (Si) content is greater than 99 mass %, the copper (Cu) content relatively decreases, so that the electrical conductivity decreases.

The copper-containing silicon material of the present invention forms a structure in which fine copper silicide is deposited within the amorphous phase containing copper and silicon. In addition, the copper-containing silicon material may contain, as impurities, calcium (Ca), fluorine (F), chlorine (Cl), oxygen (O), hydrogen (H), etc. that are derived from the raw materials thereof, and may contain nano-sized silicon crystallites or amorphous silicon.

The copper-containing silicon material of the present invention contains the copper silicide, which is electrochemically inert to lithium. Therefore, a secondary battery in which the copper-containing silicon material of the present invention is used as a negative electrode active material is expected to have improved cycle characteristics, since a volume change of Si due to charging/discharging is suppressed.

### <Negative Electrode of Secondary Battery>

The copper-containing silicon material of the present invention can be used as a negative electrode active material in a secondary battery such as a lithium ion secondary battery. The negative electrode of, for example, a nonaqueous secondary battery is produced, using the copper-containing silicon material of the present invention as a negative electrode active material, by: applying, on the current collector using a method such as roll coating method, dip coating method, doctor blade method, spray coating method, or curtain coating method, a slurry obtained through adding and mixing a powder of the copper-containing silicon material, the conductive additive such as a carbon powder if necessary, a binder, and a proper amount of an organic solvent; and drying or curing the binder.

As the binder, both a solvent-based binder and a water-based binder may be used. Examples of the solvent-based binder include polyvinylidene difluoride (PVdF), polytetrafluoroethylene (PTFE), styrene-butadiene rubber (SBR), polyimide (PI), polyamide-imide (PAI), polyamide (PA), polyvinyl chloride (PVC), polymethacrylic acid (PMA), polyacrylonitrile (PAN), modified polyphenylene oxide (PPO), polyethylene oxide (PEO), polyethylene (PE), and polypropylene (PP), etc.

The water-based binder refers to a binder that is mixed and used with an active material in a state where the binder is dispersed or dissolved in water, and, as typical examples of the water-based binder, polyacrylic acid (PAA), styrene-butadiene rubber (SBR), sodium alginate, and ammonium alginate may be used. One obtained by mixing carboxymethylcellulose (CMC) into each of these binders may be used as the water-based binder, or instead of SBR and/or PAA, CMC may be used singly as the water-based binder. In addition, as the water-based binder, a crosslinked product of a water-soluble polymer may be used, and a water-soluble cellulose ester crosslinked product such as a CMC crosslinked product, and a starch/acrylic acid graft polymer, etc. may be used.

When polyvinylidene difluoride is used as the binder, the potential of the negative electrode is reduced and the voltage of the secondary battery improves. Furthermore, using polyamide-imide (PAI) or polyacrylic acid (PAA) as the binder improves the initial efficiency and the discharge capacity of the secondary battery in some cases.

The current collector refers to a fine electron conductor that is chemically inert for continuously sending a flow of current to the electrode during discharge or charging. The current collector may be used in the form of a foil, a plate, or the like. However, the form is not particularly limited as long as the form is in accordance with the purpose. As the current collector, for example, a copper foil or an aluminum foil may be suitably used.

Regarding the negative electrode active material, a material known in the art such as graphite, hard carbon, silicon, carbon fibers, tin (Sn), and silicon oxides may be mixed into the copper-containing silicon material of the present invention. Among these materials, a silicon oxide represented by SiOₓ (0.3≦x≦1.6) is particularly preferable. Each particle of a powder of this silicon oxide is formed from SiOₓ that is decomposed into fine Si and SiO₂ covering the Si as a result of a disproportionation reaction. When x is less than the lower limit value, the Si ratio becomes high, so that the volume change during charging and discharging becomes excessively large and the cycle characteristics deteriorate. Furthermore, when x is greater than the upper limit value, the Si ratio decreases, so that the energy density decreases. The range of 0.5≦x≦1.5 is preferable, and the range of 0.7≦x≦1.2 is further preferable.

In addition, as the negative electrode active material, a material obtained by compositing 1 to 50 mass % of a carbon material with respect to SiOₓ may be used in addition to the copper-containing silicon material of the present invention. By compositing the carbon material, the cycle characteristics improve. When the composited amount of the carbon material is less than 1 mass %, the effect of improvement of electrical conductivity is not obtained. When the composited amount of the carbon material is greater than 50 mass %, the proportion of SiOₓ becomes relatively low and the negative-electrode capacity decreases. The composited amount of the carbon material with respect to SiOₓ is preferably within the range of 5 to 30 mass % and further preferably within the range of 5 to 20 mass %. CVD or the like may be used for compositing the carbon material with respect to SiOₓ.

The mean particle diameter of the silicon oxide powder is preferably within the range of 1 μm to 10 μm. When the mean particle diameter is larger than 10 μm, the durability of the secondary battery deteriorates in some cases. When the mean particle diameter is smaller than 1 μm, the durability of the secondary battery similarly deteriorates in some cases, since the silicon oxide powder aggregates to generate bulky particles.

The conductive additive is added for increasing the electrical conductivity of the electrode. The conductive additive becomes unnecessary in many cases, since the copper-containing silicon material of the present invention has high electrical conductivity. As the conductive additive to be added, carbonaceous fine particles such as carbon black, natural graphite, granulated graphite, artificial graphite, fire-resistant graphite, acetylene black (AB), Ketchen black (KB) (registered trademark), and vapor grown carbon fiber (VGCF) may be used singly, or two or more types of them may be used in combination. The usage amount of the conductive additive is not particularly limited, but may be, for example, about 20 to 100 parts by mass with respect to 100 parts by mass of the active material. When the amount of the conductive additive is less than 20 parts by mass, an efficient electrically-conductive path is not formed in some cases, and when the amount of the conductive additive is greater than 100 parts by mass, moldability of the electrode worsens and the energy density of the electrode becomes low. When a silicon oxide composited with a carbon material is used as the active material, the added amount of the conductive additive may be reduced or may be zero.

The organic solvent is not particularly limited, and a mixture of a plurality of solvents may be used. The organic solvent is particularly preferably, for example, N-methyl-2-pyrrolidone, a mixed solvent of N-methyl-2-pyrrolidone and an ester based solvent (ethyl acetate, n-butyl acetate, butyl cellosolve acetate, butyl carbitol acetate, etc.) or a mixed solvent of N-methyl-2-pyrrolidone and a glyme based solvent (diglyme, triglyme, tetraglyme, etc.).

When the secondary battery of the present invention is a lithium ion secondary battery, the negative electrode may be predoped with lithium. For the doping of the negative electrode with lithium, for example, an electrode forming method of assembling a half cell using metal lithium as a counter electrode, and electrochemically doping with lithium may be used. The degree of doping with lithium is not particularly limited.

When the secondary battery of the present invention is a lithium ion secondary battery, a not-particularly limited positive electrode, electrolytic solution, or separator known in the art may be used. Any positive electrode may be used as long as the positive electrode is one that is usable in a lithium ion secondary battery. The positive electrode includes a current collector, and a positive electrode active material layer bound on the current collector. The positive electrode active material layer contains a positive electrode active material and a binder, and may further contain a conductive additive. The positive electrode active material, the conductive additive, and the binder are not particularly limited, and those usable in a lithium ion secondary battery may be used.

Examples of the positive electrode active material include metal lithium, a Li compound or a solid solution selected from LiCoO₂, LiₓNiₐCo_{b}Mn_{c}O₂, LiₓCo_{b}Mn_{c}O₂, LiₓNiₐMn_{c}O₂, LiₓNiₐCo_{b}O₂, and Li₂MnO₃ (note that 0.5≦x≦1.5, 0.1≦a<1, 0.1≦b<1, and 0.1≦c<1), Li₂MnO₃, and sulfur, etc. As the current collector, one that is generally used for the positive electrode of a lithium ion secondary battery, such as aluminum, nickel, and stainless steel, may be used. As the conductive additive, one that is similar to that described above in relation to the negative electrode may be used.

The electrolytic solution is obtainedbydissolvinga lithium metal salt, which is an electrolyte, in the organic solvent. As the organic solvent, one or more members selected from aprotic organic solvents such as, for example, propylene carbonate (PC), ethylene carbonate (EC), dimethyl carbonate (DMC), diethyl carbonate (DEC), and ethyl methyl carbonate (EMC) may be used. As the electrolyte to be dissolved, a lithium metal salt that is soluble to the organic solvent, such as LiPF₆, LiBF₄, LiAsF₆, LiI, LiClO₄, and LiCF₃SO₃, may be used.

As the electrolytic solution, for example, a solution obtained by dissolving a lithium metal salt such as LiClO₄, LiPF₆, LiBF₄, or LiCF₃SO₃ in an organic solvent such as ethylene carbonate, dimethyl carbonate, propylene carbonate, or dimethyl carbonate at a concentration of about 0.5 mol/L to 1.7 mol/L may be used.

The separator is not particularly limited as long as the separator is one usable in a nonaqueous secondary battery. The separator serves to separate the positive electrode and the negative electrode to retain the electrolytic solution, and a thin microporous film of polyethylene, polypropylene, or the like may be used as the separator.

The form of the secondary battery of the present invention is not particularly limited, and various forms such as a cylinder type, a laminated type, and a coin type, etc., may be used. Even when any of the forms is used, a battery is formed by: making an electrode assembly by interposing the separator between the positive electrode and the negative electrode; respectively connecting a positive electrode current collector to a positive electrode external terminal and a negative electrode current collector to a negative electrode external terminal using current collecting leads or the like; and then sealing the electrode assembly together with the electrolytic solution in a battery case.

### EXAMPLES

In the following, embodiments of the present invention will be described specifically by means of Examples and Comparative Examples.

### Example 1

<First Step>

Metal calcium, metal copper, and metal silicon were weighed out in a carbon crucible in a ratio of Ca:Cu:Si=1.05:0.25:1.65 as an atom ratio, and were heated at about 1300° C. by a high-frequency induction heater to be melted. The molten metal was poured into a predetermined mold and cast to obtain an ingot. The obtained ingot was ground and sized with a sieve into a particle size that allows the particles thereof to pass through a sieve mesh of 53 μm. This powder is a copper-containing calcium silicide represented by CaCuₓSi_{y} (x=0.25, y=1.65, x+y=1.9).

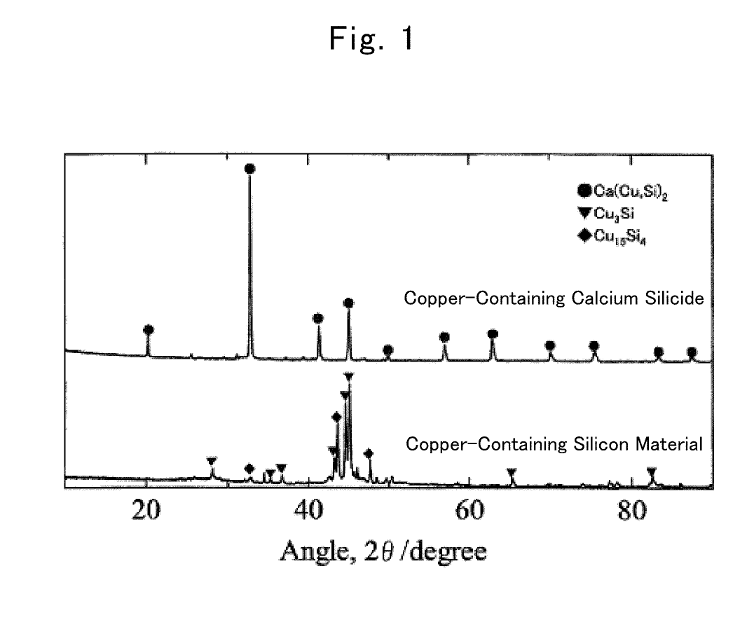

An XRD chart of the obtained copper-containing calcium silicide is shown in FIG. 1. Cu-Kα radiation was used as an X-ray source. Analysis was performed with analysis software (the software name: PDXL) by using an X-ray diffraction pattern (a diffraction angle 2θ=10° to 90°) obtained by measurement. All diffraction peaks shown in FIG. 1 were able to be indexed as a structure of space group P6/mmm with International Table No. 191.

The elemental composition of the obtained copper-containing calcium silicide was measured. An oxygen/nitrogen analyzer (“EMGA” manufactured by HORIBA, Ltd.) was used for measurement of oxygen (0), and X-ray fluorescence analysis method (XRF) was used for measurement of the other elements. The results are shown in Table 1.

<Second Step>

Twenty milliliters of an HF aqueous solution having a concentration of 55 mass % and 180 ml of an HCl aqueous solution having a concentration of 36 mass % were set to a temperature of 0° C. in an ice bath, and 5 g of the above copper-containing calcium silicide was added thereto and the mixed solution was stirred in an argon gas current. After completion of foaming was confirmed, the mixed solution was warmed to room temperature and further stirred for 1.5 hours at room temperature. At this moment, suspension of a yellow powder was observed. The obtained mixed solution was filtered, and the residue was rinsed with 200 ml of distilled water, then rinsed with 200 ml of acetone, and dried under vacuum for 12 hours to obtain 3.5 g of a silicon precursor.

<Third Step>

One gram of the silicon precursor was weighed out, and a heat treatment of keeping the silicon precursor at 500° C. was performed for 1 hour in argon gas in which the amount of O₂ was not greater than 1 vol %, to obtain 0.9 g of a copper-containing silicon material.

Measurement of X-ray diffraction (XRD measurement) using CuKα radiation was conducted on the obtained copper-containing silicon material, and an obtained XRD chart is shown in FIG. 1. Peaks ascribed to Cu₃Si and Cu₁₅Si₄ are present, and thus copper silicide is found to be contained.

In addition, the elemental composition of the obtained copper-containing silicon material was measured similarly as described above. The results are shown in Table 1.

TABLE 1

| | Elemental composition (mass %) | | | | | |
|---|---|---|---|---|---|---|
| | Ca | Cu | Si | Cl | F | O |
| Copper-containing calcium silicide | 37.3 | 14.5 | 42.2 | — | — | 0.7 |
| Copper-containing silicon material | 3.7 | 22.1 | 61.5 | 1.0 | 5.3 | 6.4 |

The total value of the copper-containing calcium silicide is not 100. The reason is that inevitable impurities such as those derived from the raw materials are contained.

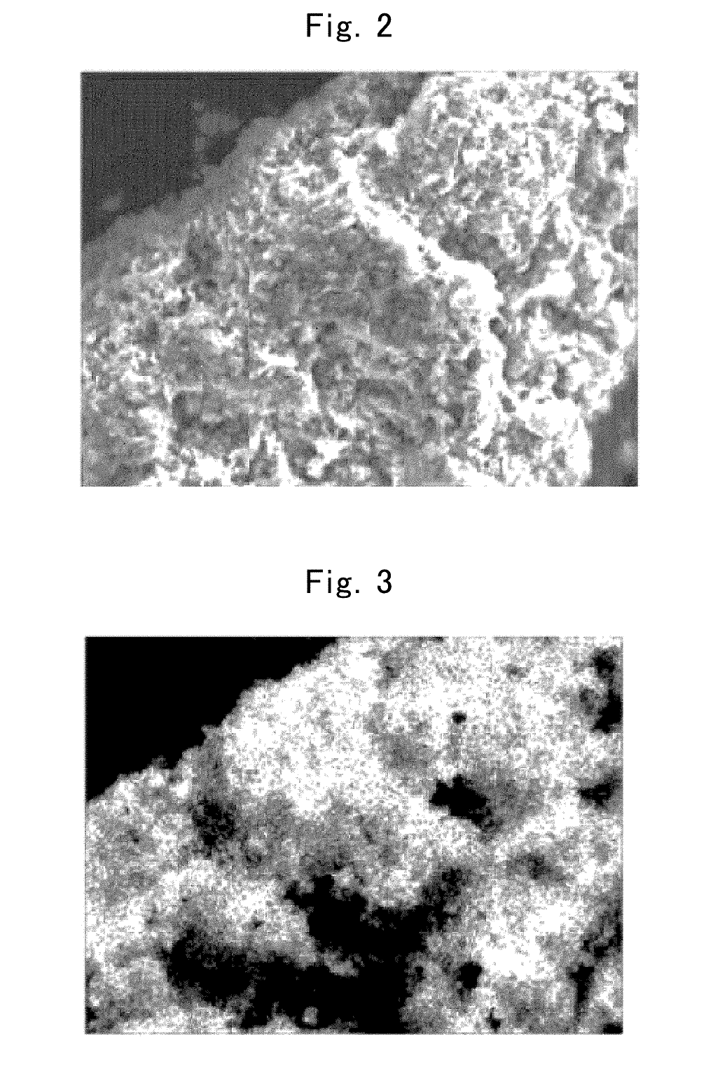

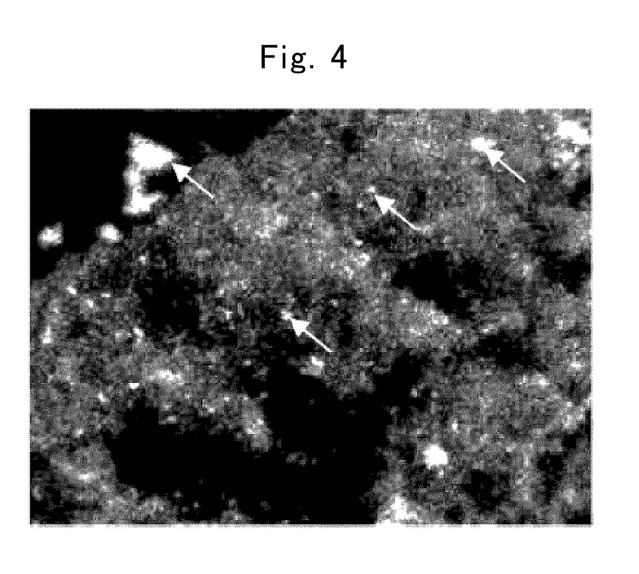

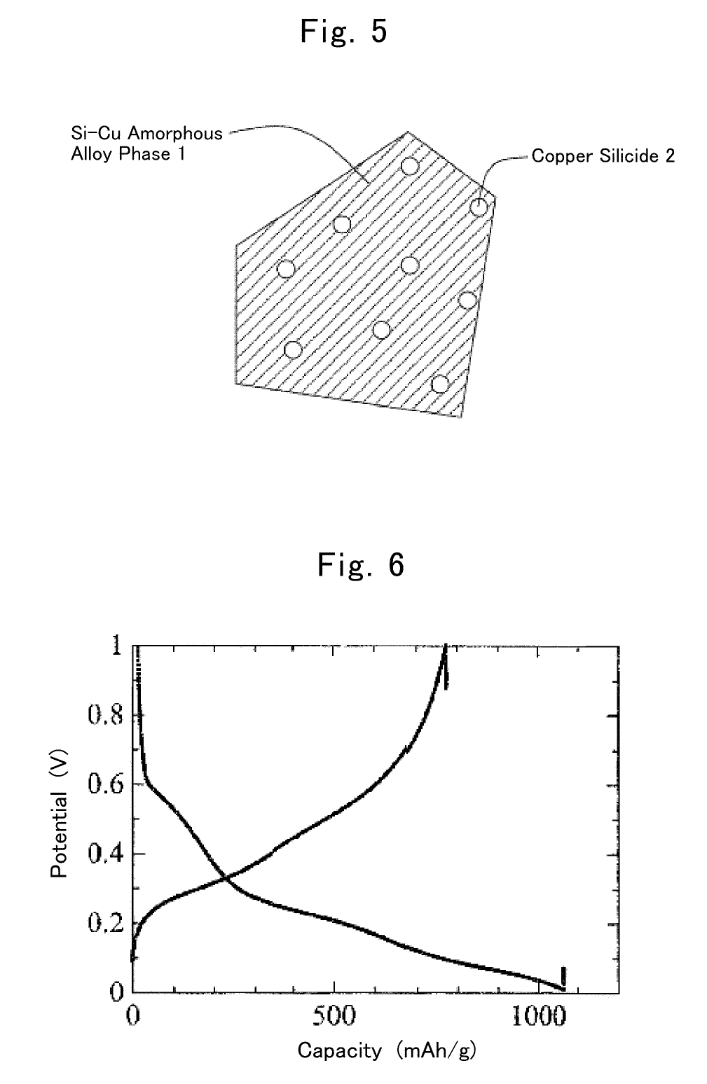

SEM observation was performed on the obtained copper-containing silicon material, and further the obtained copper-containing silicon material was analyzed by TEM-EDX (energy dispersive X-ray spectroscopy). An SEM image is shown in FIG. 2, a distribution of silicon (Si) is shown in FIG. 3, and a distribution of copper (Cu) is shown in FIG. 4. In FIG. 4, portions different in color from the surroundings thereof (portions shown by arrows) are copper silicide, and the surroundings thereof are an amorphous phase. The amorphous phase contains not only Si but also Cu and thus is thought to form an Si—Cu amorphous alloy. That is, as schematically shown in FIG. 5, the copper-containing silicon material of the present embodiment is thought to be formed from an Si-Cu amorphous alloy phase 1 and copper silicide 2 deposited substantially uniformly within the Si—Cu amorphous alloy phase 1.

<Lithium Ion Secondary Battery>

A slurry was prepared by mixing 85 parts by mass of a powder of the obtained copper-containing silicon material, 5 parts by mass of acetylene black, and 33 parts by mass of a binder solution. As the binder solution, a solution in which a polyamide-imide (PAI) resin was dissolved in N-methyl-2-pyrrolidone (NMP) in 30 mass % is used. The slurry was applied on the surface of an electrolytic copper foil (current collector) having a thickness of approximately 20 μm by using a doctor blade, and dried to form a negative electrode active material layer on the copper foil. Then, the current collector and the negative electrode active material layer were firmly adhered and joined by using a roll press machine. The obtained joined object was vacuum dried at 200° C. for 2 hours to form a negative electrode in which the thickness of the negative electrode active material layer was 20 μm.

A lithium ion secondary battery (half cell) was produced by using, as an evaluation electrode, the negative electrode produced by the above-described procedure. A metal lithium foil (thickness: 500 μm) was used as a counter electrode.

The counter electrode and the evaluation electrode were respectively cut to have diameters of 14 mm and 11 mm, and a separator (a glass filter manufactured by the Hoechst Celanese Corp., and “Celgard 2400” manufactured by Celgard LLC.) was interposed between both electrodes to form an electrode assembly battery. The electrode assembly battery was housed in a battery case (a member for CR2032 type coin batteries, manufactured by Hohsen Corp.). A nonaqueous electrolytic solution obtained by dissolving LiPF₆ at a concentration of 1 M in a mixed solvent in which ethylene carbonate and diethyl carbonate were mixed at 1:1 (volume ratio) was poured in the battery case, and then the battery case was sealed to obtain a lithium ion secondary battery.

### Comparative Example 1

Metal calcium and metal silicon were weighed out in a carbon crucible in a ratio of Ca:Si=1.05:2 as an atom ratio, and were melted at about 1100° C. by a high-frequency induction heater. The molten metal was poured into a predetermined mold and cast to obtain an ingot. A heat treatment was performed on the obtained ingot at 900° C. for 12 hours in argon gas in which the amount of O₂ was not greater than 1 vol o, to obtain homogeneous calcium disilicide (CaSi₂). The obtained calcium disilicide was sized similarly to Example 1, and then a second step and a third step were performed similarly to Example 1, to obtain a silicon material.

<Resistance Measurement>

A powder of the copper-containing silicon material of Example 1 and a powder of the silicon material of Comparative Example 1 were made into pellets, and the volume resistivities thereof were measured by four-point probe method. The results are shown in Table 2.

TABLE 2

| | Volume resistivity (Ω · cm) |
|---|---|
| Example 1 | 0.8 |
| Comparative Example 1 | 10⁸ or higher |

The silicon material of Comparative Example 1 had immeasurably high resistance, since the silicon material does not contain copper (Cu). On the other hand, the copper-containing silicon material of Example 1 is found to have very low conductive resistance.

<Battery Characteristic Test>

For the lithium secondary battery of Example 1, a charge/discharge test was conducted under the conditions of temperature: 25° C., current: 0.1 C, and voltage: 0.01 to 1.0 V. Charging/discharging curves are shown in FIG. 6, and the charge capacity, the discharge capacity, and the initial efficiency (100×charge capacity/discharge capacity) are shown in Table 3. A battery using the silicon material of Comparative Example 1 does not function properly as a battery, since the resistance of the silicon material is excessively high as shown in Table 2. Thus, for Comparative Example 1, a battery was not made and a battery characteristic test was not conducted.

TABLE 3

| | Discharge | | Initial |
|---|---|---|---|
| | capacity | Charge capacity | efficiency |
| | (mAh/g) | (mAh/g) | (%) |
| Example 1 | 1060 | 778 | 73 |

The lithium ion secondary battery in which the copper-containing silicon material of Example 1 is used as a negative electrode active material obviously has a sufficient function as a secondary battery.

### INDUSTRIAL APPLICABILITY

The copper-containing silicon material of the present invention can be utilized as, for example, the negative electrode active material of an electrical storage device such as secondary batteries, electric double layer capacitors, lithium ion capacitors, and the like. The secondary battery is useful as a nonaqueous secondary battery utilized for driving motors of electric vehicles and hybrid automobiles and for personal computers, portable communication devices, home appliance, office instrument, industrial instrument, and the like, and can be suitably used particularly for driving motors of electric vehicles and hybrid automobiles requiring large capacity and large output.

Furthermore, the copper-containing silicon material of the present invention has a high degree of freedom of the heat treatment temperature and can be composited with another material by controlling the magnitude of the specific surface area thereof. Thus, the silicon material of the present invention can be utilized as a semiconductor material such as for CMOS and semiconductor memory, a solar battery material, and a photocatalyst material, etc.

1. A method for producing a copper-containing silicon material, the method comprising:
a first step of preparing a calcium source, a copper source, and a silicon source, preparing a molten metal by mixing and melting the calcium source, the copper source, and the silicon source such that calcium (Ca), copper (Cu), and silicon (Si) have a predetermined ratio as an atom ratio, and cooling the molten metal, to form a copper-containing calcium silicide having a composition of Ca, Cu, and Si represented by a formula CaCuₓSi_{y} (x and y satisfy 0.1≦x≦0.7, 1.33≦y≦2.1, and 1.8≦x+y≦2.2);
a second step of causing a reaction between the copper-containing calcium silicide and an acid that extracts calcium (Ca) from the copper-containing calcium silicide, to form a silicon precursor; and
a third step of performing a heat treatment in a non-oxidizing atmosphere on the silicon precursor.

2. The method for producing the copper-containing silicon material according to claim 1, wherein the calcium source, the copper source, and the silicon source are metal calcium, metal copper, and metal silicon, respectively.

3. The method for producing the copper-containing silicon material according to claim 1, wherein a heat treatment temperature in the third step is 350° C. to 950° C.

4. The method for producing the copper-containing silicon material according to claim 1, wherein the copper-containing calcium silicide has a crystal structure that belongs to P6/mmm space group.

5. A copper-containing silicon material obtained by the method according to claim 1.

6. The copper-containing silicon material according to claim 5, wherein the copper-containing silicon material contains 1 to 50 mass % of copper (Cu).

7. The copper-containing silicon material according to claim 5, wherein the copper-containing silicon material contains an amorphous phase and copper silicide deposited within the amorphous phase.

8. The copper-containing silicon material according to claim 7, wherein the amorphous phase contains silicon and copper.

9. A negative electrode active material formed from the copper-containing silicon material according to claim 5.

10. A secondary battery comprising a negative electrode containing the negative electrode active material according to claim 9.

11. (canceled)
